(19) United States
(12) Patent Application Publication
(10) Pub. No.: US 2019/0263521 A1
(43) Pub. Date: Aug. 29, 2019

(54) SYSTEM AND METHOD FOR UTILIZING A DRONE FOR A PACKAGE DELIVERY

(71) Applicant: Walmart Apollo, LLC, Bentonville, AR (US)

(72) Inventors: John J. O'BRIEN, Farmington, AR (US); Donald R. HIGH, Noel, MO (US); Justin SCHUHARDT, Montara, CA (US); Brian MCHALE, Oldham (GB); Robert CANTRELL, Herndon, VA (US)

(73) Assignee: Walmart Apollo, LLC, Bentonville, AR (US)

(21) Appl. No.: 16/285,810

(22) Filed: Feb. 26, 2019

Related U.S. Application Data
(60) Provisional application No. 62/636,801, filed on Feb. 28, 2018.

(51) Int. Cl. B64D 1/10; B64C 39/02; G06Q 10/08; B64D 1/12; B64D 9/00

(52) U.S. Cl. CPC B64D 1/10; B64C 39/024; B64C 2201/128; B64D 1/12; B64D 9/00; G06Q 10/0832

(57) ABSTRACT

Methods and systems of utilizing a drone for a package delivery are provided. An example method can include: receiving, by a central server, a request from a customer device, the request comprising one or more ordered items and a delivery destination; determining, by a processor at a central server and based on the request, instructions of a flight mission for a drone at a distribution center; instructing a first control system at a distribution center to place the ordered items into a bag; loading the bag into one of a plurality of cargo bays; providing the instructions of the flight mission to a second control system to control the drone to navigate to the delivery destination; and controlling the drone by the second control system to automatically release the bag with the ordered items from the cargo bay, the cargo bay remaining with the drone.

### CROSS-REFERENCE TO RELATED APPLICATION

This present Patent Application claims priority benefit of U.S. Provisional Application No. 62/636,801, filed on Feb. 28, 2018, which is incorporated herein by reference in its entirety.

### TECHNICAL FIELD

The present disclosure relates to package delivery, and more specifically to system and method for utilizing a drone for package delivery.

### BACKGROUND

Autonomous vehicles including aerial vehicles such as unmanned aerial vehicles (UAVs) (e.g., drones) can be used for performing surveillance, reconnaissance, and exploration tasks for military and civilian applications. Drones are generally aerial vehicles that operate without a human pilot aboard. Product delivery using drones may be becoming more prevalent in society. Currently, after a customer places an online order for purchasing products, a merchant normally has to place a collection of products into one or more boxes before delivering them to a customer location. The shipping boxes will then be discarded after the customer receives the products. The large amount of online orders has created a big burden of box recycling and waste.

Considering resource consumption, efficiency, and cost-savings related to product deliveries, there is a need to provide a more efficient package delivery system and method for efficient delivery and cost-saving for customers and merchants.

### SUMMARY

In an embodiment of the present invention, a system comprising: a central server comprising at least one processor and at least one memory; a distribution center comprising a first control system; a drone comprising: a second control system; a modular container comprising a side-hatch release mechanism; a multi-directional hook system; a drone payload area; and wherein the central server is configured to: receive a request from a customer device via the central server, the request comprising one or more ordered items and a delivery destination; determine, based on the request, instructions of a flight mission for the drone at a distribution center; and instruct a first control system at a distribution center to place the ordered items into a bag and load the bag into a modular container; wherein the second control system is configured to: receive the instructions of the flight mission; automatically load the modular container to the drone payload area; control the drone to navigate to the delivery destination; and when the drone arrives at the delivery destination, automatically control the drone to release the bag with the ordered items by the multi-directional hook system from the modular container, the modular container remaining with the drone.

In another embodiment of the present invention, a system comprising: a central server comprising at least one processor and at least one memory; a distribution center comprising a first control system; a drone comprising: a second control system; a modular container comprising a side-hatch release mechanism; a multi-directional hook system; a drone payload area; and a plurality of cargo bays configured to be inserted into the drone to accommodate a number of different package sizes and weights; wherein the central server is configured to: receive a request from a customer device via the central server, the request comprising one or more ordered items and a delivery destination; and determine, based on the request, instructions of a flight mission for the drone at a distribution center; and instructing a first control system at a distribution center to place the ordered items into a bag and load the bag into one of the plurality of cargo bays; wherein the second control system is configured to: receive the instructions of the flight mission via a control system of the drone; automatically loading the bag with the items to one of plurality of cargo bays located at a drone payload area; controlling the drone to navigate to the delivery destination; and when the drone arrives at the delivery destination, automatically controlling the drone to release the bag with the ordered items by the multi-directional hook system from the cargo bay, the cargo bay remaining with the drone.

In yet another embodiment of the present invention, a method comprising: receiving, by a central server, a request from a customer device, the request comprising one or more ordered items and a delivery destination; determining, by a processor at a central server and based on the request, instructions of a flight mission for a drone at a distribution center; instructing a first control system at a distribution center to place the ordered items into a bag; loading the bag into one of a plurality of cargo bays; providing the instructions of the flight mission to a second control system to control the drone to navigate to the delivery destination; and controlling the drone by the second control system to automatically release the bag with the ordered items by the multi-directional hook system from the cargo bay, the cargo bay remaining with the drone.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Example embodiments of this disclosure are illustrated by way of an example and not limited in the figures of the accompanying drawings, in which like references indicate similar elements and in which:

FIG. 1 is a block diagram illustrating an example environment in which some example embodiments may be implemented;

FIG. 2 illustrates an example unmanned aerial vehicle (UAV) in accordance with some example embodiments;

FIG. 3 is a diagram illustrating an example UAV and some related components in accordance with some example embodiments;

FIG. 4 is a flowchart diagram illustrating a method for utilizing drones for implementing an alternative package delivery in accordance with some example embodiments; and

FIG. 5 is a block diagram of an example computer system in which some example embodiments may be implemented.

It is to be understood that both the foregoing general description and the following detailed description are example and explanatory and are intended to provide further explanations of the invention as claimed only and are, therefore, not intended to necessarily limit the scope of the disclosure.

### DETAILED DESCRIPTION

Various example embodiments of the present disclosure will be described in detail below with reference to the accompanying drawings. Throughout the specification, like reference numerals denote like elements having the same or similar functions. While specific implementations and example embodiments are described, it should be understood that this is done for illustration purposes only. Other components and configurations may be used without parting from the spirit and scope of the disclosure, and can be implemented in combinations of the variations provided. These variations shall be described herein as the various embodiments are set forth.

The concepts disclosed herein are directed to provide a more cost-effective system and method for a drone package delivery. The system may eliminate a box for carrying a collection of products.

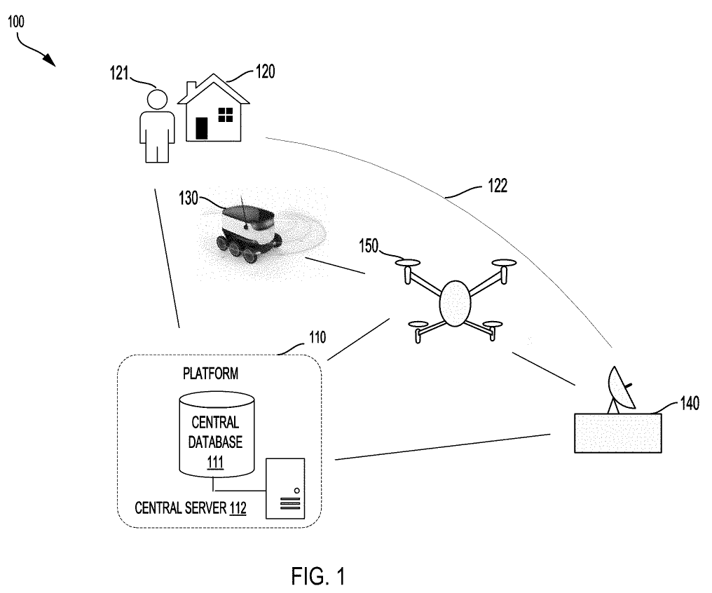

FIG. 1 is a block diagram illustrating an example environment in which some example embodiments may be implemented. The example environment generally includes one or more of platform 110, package destination 120, customer 121, Autonomous Ground Vehicles (AGVs) 130, distribution center 140, drones 150, and network (not shown).

The platform 110 may be a network-accessible computing platform and may be implemented as a computing infrastructure of one or more servers and databases including processors, memory (data storage), software, data access interface, and other components that are accessible via wireless or wired networks. One or more servers are shown and referred to as central server 112 for simplicity. One or more databases are shown and referred to as a central database 111 herein for simplicity. These servers may include one or more processors and memory which may be utilized to operate a drone management system. In some example embodiments, platform 110 may communicate with drones and AGVs to complete missions for delivering one or more products or conducting specific operations.

Customer 121 may create, via central server 112 and network, an account with platform 110 by creating a customer profile to store personal information and credentials of customer in central database 111. Each account profile may be configured to store data related to an existing customer including customer's username, email address, password, phone number, customer's rating, drone delivery information, delivery (residential) address, payment transaction accounts, purchasing preference, search history, order history, information, other relevant demographic or analytical data, third parties including family members, friends, or neighbors, etc. The drone delivery information may include drone delivery destination, nearby pickup site information, delivery preference, drone delivery pickup timeslots, and other type of information related to drone delivery.

In the example environment 100, a network (not shown) may include satellite-based navigation system or a terrestrial wireless network, Wi-Fi, and other type of wired or wireless networks to facilitate communications between the various network devices associated with the example environment.

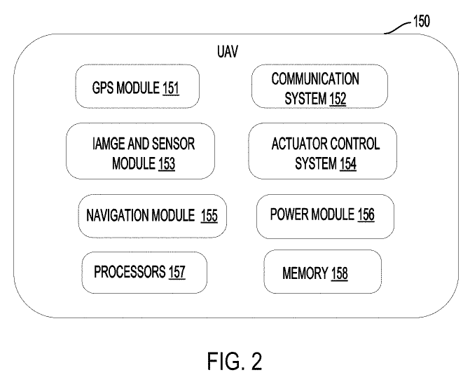

FIG. 2 illustrates an example unmanned aerial vehicle (UAV) in accordance with some example embodiments. Referring to FIG. 2, the UAV 150 or drone may include GPS module 151, communication system 152, image and sensor module 153, actuator control system 154, navigation module 155, power module 156, processors 157 and memory (data storage) 158, and other mechanical components. The communication system 152 may allow the drone to communicate with computing devices or processors in the environment for conducting operations and delivering packages. The communication system 152 can be configured to permit the drone to communicate with another drone and the central server 112 on different transmission paths or routes. The communication system 152 may utilize cellular, radio frequency, near field communication, infrared, Bluetooth, Wi-Fi, satellite, or any other means for communication. The processors 157 are in communication with different modules of the drone.

The image and sensor module 153 of the drone may include one or more onboard cameras, one or more visual sensors, proximity sensors, and other types of sensors. These cameras and sensors may be placed on one or more surfaces of the drone. The image and sensor module 153 can determine information on the internal and/or external state of the drone. As such, the sensors can determine the position and movement of the drone. In addition, the sensors can determine one or more internal properties of the drone, including, for example, an amount of energy capable of being provided by the power module 156.

The drone may also include GPS module 151, navigation module 155 and one or more processors 157, which may determine positioning information for the drone, guide drone navigating to a mission destination and conduct specific operations or data analysis.

In some example embodiments, operational parameters of the drone may comprise GPS information, flight heights, flight speeds, flight route, package weight, package capacity, battery information, direction, air speed, etc. In some example embodiments, the instructions of a flight mission may comprise package original location, package destination, package weight, package capacity, operational parameters of the drone, flight route, and assigned work.

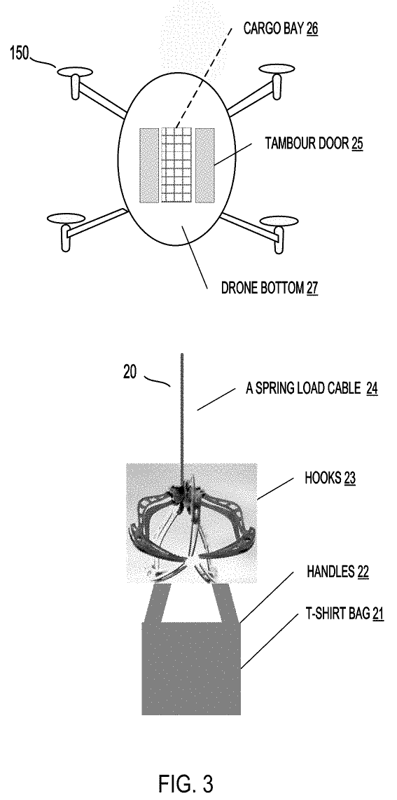

FIG. 3 is a diagram illustrating an example drone and some related components in accordance with some example embodiments. The drone may include some sub-systems or components to facilitate a package delivery.

In some example embodiments, the drone 150 may further include a control system, a modular container comprising a side-hatch release mechanism, a multi-directional hook system 20, and a drone payload area.

In some example embodiments, a customer's ordered products may be placed into a bag and loaded into the modular container by a control system at a distribution center. The modular container may then be loaded into the drone's payload area. The modular container may include a side-hatch release mechanism for loading and unloading the products. When the drone delivers the package to the delivery location, the drone may have different ways to release the products contained in the modular container. The packages may be automatically loaded into the drone's payload area and unloaded form the drone's payload area.

The drone may further include a double tambour door 25 which opens at the drone bottom 27 to allow the bag 21 to be lowered down. The control system of the drone 150 may further include a robotic arm with an elbow to grab and transfer the bag to a multi-directional hook system 20. The drone may include an open top with petal like door elements located at the bottom of the drone for delivery based on a gravity.

In some example embodiments, the multi-directional hook system 20 may be communicated with and controlled by the processor of the drone to perform variety of operations. The multi-directional hook system 20 may be configured to latch onto and release a package in order to load and unload packages. The multi-directional hook system may comprise a plurality of hooks configured to grab handles of the bag for releasing the bag to the delivery destination. The multi-directional hook system 20 may further comprise a spring loaded cable 24. The spring loaded cable 24 may be configured to automatically latch onto and release the bag. The bag may have multiple handles 22 to be grabbed by a robotic arm. The spring loaded cable 24 may have two ends. A first end of the spring loaded cable 24 may be connected to a hook and a second end of the spring loaded cable 24 may be connected to the drone.

In some example embodiment, the drone 150 may include a plurality of cargo bays 26. Each cargo bay may be designed as a modular device and configured to be inserted into drone's payload area or engaged with the drone 150. Various cargo bays or modules may be provided to accommodate a number of different package sizes, weights, etc. A cargo bay 26 may have a capability to receive and deliver a particular package. For example, some cargo bays may be designed to accommodate bags 21 with packages. The plurality of the cargo bays 26 may be arranged in rows or columns based on the package sizes and engaged with the drone 150. Each cargo bay 26 may be configured with a particular identification number associated with a particular package.

In one example embodiment, the bag 21 may have mesh holes and the hooks may extend through the holes in the mesh to secure the order. The mesh holes may allow the air to enter. This may help to keep some food products fresh. The bag 21 may be made from durable, reusable, cost-effective, or disposable material. The bag may be made from other cost-effective advanced materials and may be made in other forms or appearances.

The drone may include a plurality of a fitted box for store bagged products. Each fitted box may be secured to the drone for transport of the bagged products. For example, the fitted box may be secured into a modular container. The modular container may be loaded into one of plurality of cargo bays.

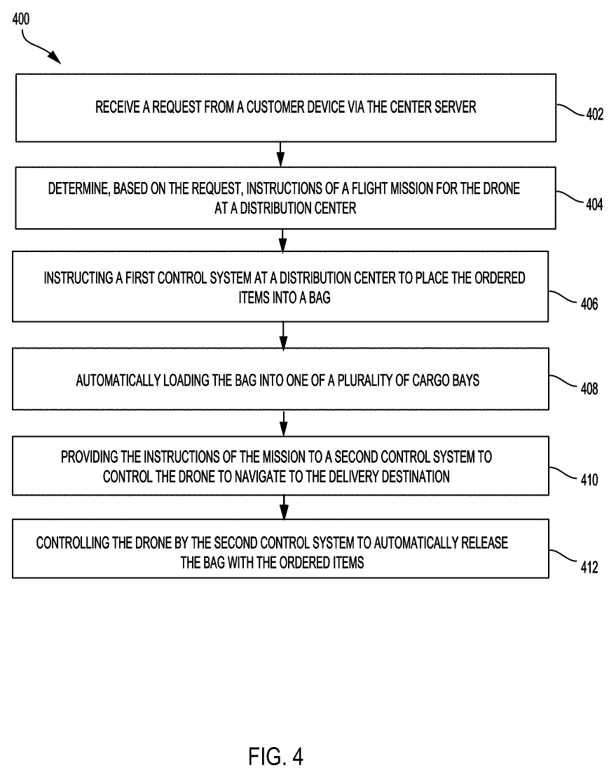

FIG. 4 is a flowchart diagram illustrating an example process 400 for a package delivery. The process 400 may be implemented in the above described systems and may include the following steps. Steps may be omitted, ordered or combined depending on the operations being performed.

In some example embodiments, the system may automatically control loading the product into the drone; and launching the drone from a distribution center.

In step 402, a central server may receive a request from a customer device for delivering one or more items to a delivery destination.

In step 404, a processor at a central server may determine, based on the request, instructions of a flight mission for a drone at a distribution center.

In step 406, the central server may instruct a first control system at a distribution center to place the ordered items into a receptacle, such as a bag.

In step 408, the bag may be automatically loaded into a drone payload area of the drone by a first control system at a distribution center or by other loading mechanism. In one example embodiment, the system may first load the bag into a modular container and then the modular container may be loaded in one of a plurality of cargo bays for delivery of the customer's products. The modular container may include a side-hatch release mechanism for loading and unloading the products.

In step 410, the central server may provide the instructions of the flight mission to a second control system to control the drone to navigate to the delivery destination.

In step 412, when the drone arrives at the delivery destination, the second control system in the drone may control the drone to automatically release the bag with the ordered items from the modular container by a multi-directional hook system. The modular container may still remain with the drone after the delivery.

In one example embodiment, when the drone detects an arrival at the delivery destination, the second control system in the drone may control the double tambour door 25 to open at a bottom. The robotic arm with an elbow may catch the bag and transfer to the multi-directional hook system. The robotic arm may be controlled to detect the hooks and put the bag on the hooks 23 of the multi-directional hook system 20. The multi-directional hook system 20 may be controlled by the control system to secure and lower down the bag to the ground.

In one example embodiment, the drone descends diagonally and opens a side door to eject the bag.

In one example embodiment, the drone may contain a box which has a bottom that pivots to slope down to drop the bag.

In one example embodiment, the drone may have a pair of hooks which pivot to lock the bag in place until time for delivery. The hooks may pivot to compress the bag against a surface, holding the bag in place, as well as reducing the footprint of the bag. This method works best with non-fragile items.

In one example embodiment, the drone may carry the products in a bag which has air inflatable bladders and can be inflated upon delivery by a compressor or compressed gas canister carried by the drone. In one example embodiment, the drone may carry the product box (original product packaging only) with a pair of grippers until delivery. The pair of the gripper may be grabbed by the robotic arm to be carried by the multi-directional hook system. The pair of the gripper may be grabbed by the multi-directional hook system directly for lowering the product box to the ground.

In one example embodiment, the drone may carry the products to the delivery destination and then load the products into a bag by the robotic arm, which eliminates loading the products into a bag at the delivery center.

In one example embodiment, the system may comprise a supplemental packaging system to use airbags to package and protect fragile items in packages. The air bags may be part of the drone and inflated to fit the packages loaded. For example, in one example embodiment, the system may use hinges to connect to and release a package.

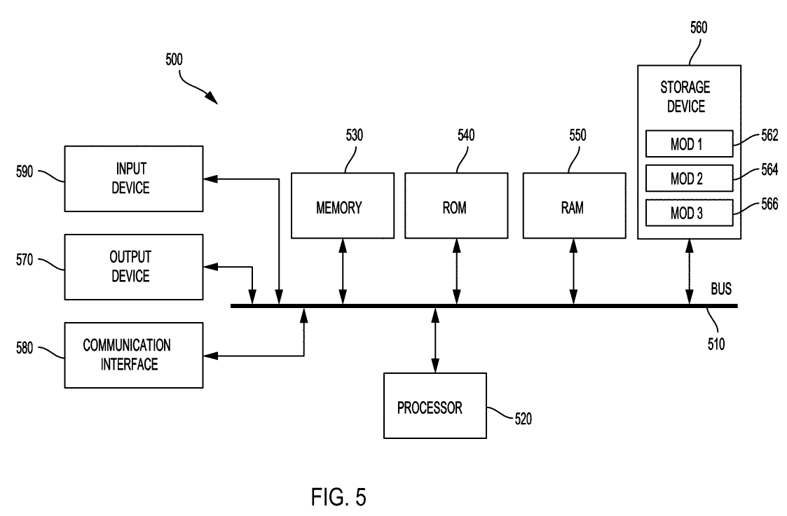

FIG. 5 illustrates an example computer device 500 which may be used to implement embodiments as disclosed herein. The computing device 500 may be a server, a personal computer (PC), or another type of computing device. With reference to FIG. 5, an example computing device 500 can include a processing unit (CPU or processor) 520 and a system bus 510 that couples various system components including the system memory 530 such as read only memory (ROM) 540 and random access memory (RAM) 550 to the processor 520. The computing device 500 can include a cache of high speed memory connected directly with, in close proximity to, or integrated as part of the processor 520. The computing device 500 copies data from the memory 530 and/or the storage device 560 to the cache for quick access by the processor 520. In this way, the cache provides a performance boost that avoids processor 520 delays while waiting for data. These and other modules can control or be configured to control the processor 520 to perform various actions. Other system memory 530 may be available for use as well. The memory 530 can include multiple different types of memory with different performance characteristics. It can be appreciated that the disclosure may operate on a computing device 500 with more than one processor 520 or on a group or cluster of computing devices networked together to provide greater processing capability. The processor 520 can include any general purpose processor and a hardware module or software module, such as module 1 562, module 2 564, and module 3 566 stored in storage device 560, configured to control the processor 520 as well as a special-purpose processor where software instructions are incorporated into the actual processor design. The processor 520 may essentially be a completely self-contained computing system, containing multiple cores or processors, a bus, memory controller, cache, etc. A multi-core processor may be symmetric or asymmetric.

The system bus 510 may be any of several types of bus structures including a memory bus or memory controller, a peripheral bus, and a local bus using any of a variety of bus architectures. A basic input/output (BIOS) stored in ROM 540 or the like, may provide the basic routine that helps to transfer information between elements within the computing device 500, such as during start-up. The computing device 500 further includes storage devices 560 such as a hard disk drive, a magnetic disk drive, an optical disk drive, tape drive or the like. The storage device 560 can include software modules 562, 564, 566 for controlling the processor 520. Other hardware or software modules are contemplated. The storage device 560 is connected to the system bus 510 by a drive interface. The drives and the associated computer-readable storage media provide nonvolatile storage of computer-readable instructions, data structures, program modules and other data for the computing device 500. In one aspect, a hardware module that performs a particular function includes the software component stored in a tangible computer-readable storage medium in connection with the necessary hardware components, such as the processor 520, bus 510, display 570, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the computing device 500 is a small, handheld computing device, a desktop computer, or a computer server.

Although the exemplary embodiment described herein employs the hard disk 560, other types of computer-readable media which can store data that are accessible by a computer, such as magnetic cassettes, flash memory cards, digital versatile disks, cartridges, random access memories (RAMs) 550, and read only memory (ROM) 540, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 500, an input device 590 represents any number of input mechanisms, such as a microphone for speech, a touch-sensitive screen for gesture or graphical input, keyboard, mouse, motion input, speech and so forth. An output device 570 can also be one or more of a number of output mechanisms known to those of skill in the art. In some instances, multimodal systems enable a user to provide multiple types of input to communicate with the computing device 500. The communications interface 580 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

What is claimed is:

1. A system comprising:
a central server comprising at least one processor and at least one memory;
a distribution center comprising a first control system;
a drone comprising:
a second control system;
a modular container comprising a side-hatch release mechanism;
a multi-directional hook system;
a drone payload area; and
wherein the central server is configured to:
receive a request from a customer device via the central server, the request comprising one or more ordered items and a delivery destination;
determine, based on the request, instructions of a flight mission for the drone at a distribution center; and
instruct a first control system at a distribution center to place the ordered items into a bag and load the bag into a modular container;
wherein the second control system is configured to:
receive the instructions of the flight mission;
automatically load the modular container to the drone payload area;
control the drone to navigate to the delivery destination; and
when the drone arrives at the delivery destination, automatically control the drone to release the bag with the ordered items by the multi-directional hook system from the modular container, the modular container remaining with the drone.

2. The system of claim 1, wherein the side-hatch release mechanism is configured to load and unload the ordered items to and from the modular container.

3. The system of claim 1, wherein the multi-directional hook system is configured to automatically latch onto and release the bag with the ordered items to the delivery destination.

4. The system of claim 1, wherein the system further comprises a supplemental packaging system that is configured to use an airbag to package and protect fragile items.

5. The system of claim 1, wherein the bag has multiple handles up and is made from durable, reusable, cost-effective, or disposable material.

6. The system of claim 1, wherein the multi-directional hook system comprises a plurality of hooks configured to grab the multiple handles of the bag for releasing the bag to the delivery destination.

7. The system of claim 1, wherein the multi-directional hook system further comprises a spring loaded cable, wherein the spring loaded cable has two ends, and a first end of the spring loaded cable is connected to a hook and a second end of the spring loaded cable is connected to the drone.

8. The system of claim 1, wherein the drone further comprises:
a double tambour door which opens at a bottom to allow the bag to be lowered down;
a robotic arm with an elbow to secure and lower the bag;
an open top with petal like door elements located the bottom of the drone for delivery based on a gravity;
a fitted box configured to secure to the drone for transport of bagged items while the drone descends diagonally and opens a side door to eject the bag; and
a winch to be configured to lower a hinge which supports the ordered items in the bag.

9. A system comprising:
a central server comprising at least one processor and at least one memory;
a distribution center comprising a first control system;
a drone comprising:
a second control system;
a modular container comprising a side-hatch release mechanism;
a multi-directional hook system;
a drone payload area; and
a plurality of cargo bays configured to be inserted into the drone to accommodate a number of different package sizes and weights;
wherein the central server is configured to:
receive a request from a customer device, the request comprising one or more ordered items and a delivery destination;
determine, based on the request, instructions of a flight mission for the drone at a distribution center; and
instruct a first control system at a distribution center to place the ordered items into a bag;
wherein the second control system is configured to:
receive the instructions of the flight mission;
automatically load the bag with the ordered items to one of plurality of cargo bays located at a drone payload area;
control the drone to navigate to the delivery destination; and
when the drone arrives at the delivery destination, automatically control the drone to release the bag with the ordered items by the multi-directional hook system from the cargo bay, the cargo bay remaining with the drone.

10. The system of claim 9, wherein the side-hatch release mechanism is configured to load and unload the ordered items to and from the modular container.

11. The system of claim 9, wherein the multi-directional hook system is configured to automatically latch onto and release the bag with the ordered items to the delivery destination.

12. The system of claim 9, further comprising a supplemental packaging system that is configured to use an airbag to package and protect fragile items.

13. The system of claim 9, wherein the bag has multiple handles up and is made from durable, reusable, cost-effective, or disposable material.

14. The system of claim 9, wherein the multi-directional hook system comprises a plurality hooks configured to grab the multiple handles of the bag for releasing the bag to the delivery destination.

15. The system of claim 9, wherein the multi-directional hook system further comprises a spring loaded cable, wherein the spring loaded cable has two ends, and a first end of the spring loaded cable is connected to a hook and a second end of the spring loaded cable is connected to the drone.

16. The system of claim 9, wherein the drone further comprises:
a double tambour door which opens at a bottom to allow the bag to be lowered down;
a robotic arm with an elbow to secure and lower the bag;
an open top with petal like door elements located at the bottom of the drone for delivery based on a gravity;
a fitted box configured to secure to the drone for transport of bagged items while the drone descends diagonally and opens a side door to eject the bag; and
a winch to be configured to lower a hinge which supports the ordered items in the bag.

17. The system of claim 9, wherein one or more cargo bays is configured to accommodate a bag with the ordered items.

18. A method, comprising:
receiving, by a central server, a request from a customer device, the request comprising one or more ordered items and a delivery destination;
determining, by a processor at a central server and based on the request, instructions of a flight mission for a drone at a distribution center;
instructing a first control system at a distribution center to place the ordered items into a bag;
loading the bag into one of a plurality of cargo bays;
providing the instructions of the flight mission to a second control system to control the drone to navigate to the delivery destination; and
when the drone arrives at the delivery destination, controlling the drone by the second control system to automatically release the bag with the ordered items by a multi-directional hook system from the cargo bay, the cargo bay remaining with the drone.

19. A method of claim 18, wherein the drone comprises a plurality of cargo bays which are configured to be inserted into the drone to accommodate a number of packages with different sizes and weights.

20. A method of claim 19, further comprising:
loading the bag into a modular container; and
loading the modular container into one of plurality of cargo bays.
